(19) United States
(12) Patent Application Publication
(10) Pub. No.: US 2023/0331568 A1
(43) Pub. Date: Oct. 19, 2023

(54) METHODS OF PRODUCING NANO-SIZED, MESOPOROUS ZEOLITES

(71) Applicant: Saudi Arabian Oil Company, Dhahran (SA)

(72) Inventors: Faisal Alotaibi, Al Khobar (SA); Shouq Alqoroni, Dhahran (SA); Lianhui Ding, Dhahran (SA); Khalid Otaibi, Dhahran (SA)

(73) Assignee: Saudi Arabian Oil Company, Dhahran (SA)

(21) Appl. No.: 17/723,593

(22) Filed: Apr. 19, 2022

(51) Int. Cl. C01B 39/46; B01J 29/70; B01J 21/04; C10G 11/05

(52) U.S. Cl. CPC C01B 39/46; B01J 29/7007; B01J 21/04; C10G 11/05; C01P 2004/64; C01P 2006/14; C01P 2006/12; C10G 2300/70

(57) ABSTRACT

According to embodiments disclosed herein, a method of forming nano-sized, mesoporous zeolite particles may include contacting initial nano-sized zeolite particles with a first mixture to form nano-sized, mesoporous zeolite particles from the initial nano-sized zeolite particles. The initial nano-sized zeolite particles may have a particle size of less than or equal to 100 nm and may have an average pore size of less than 2 nm. The first mixture may include NaOH; NH₄NO₃, NH₄OH, or both; and a surfactant. The NaOH and the surfactant may interact with the initial nano-sized zeolite particles to remove one or more silica components of the initial nano-sized zeolite particles to form mesopores. The NH₄NO₃, NH₄OH, or both may interact with the initial nano-sized zeolite particles to exchange at least one positively-charged ion from the NH₄NO₃, NH₄OH, or both with at least one positively-charged ion from the initial nano-sized zeolite particles.

### TECHNICAL FIELD

The present disclosure relates to zeolites, and more specifically, to methods of producing zeolites.

### BACKGROUND

Numerous processes may be used in order to form zeolites, which are useful in many industrial applications such as chemical cracking. In some of these processes, zeolite frameworks may comprise pores in order for chemical compounds to reach active sites within the zeolite. Additionally, in some of these processes, at least one cation may be present in at least a portion of one or more zeolite frameworks. However, improved methods for producing zeolites are needed.

### SUMMARY

Numerous conventional zeolites are used as catalysts to convert various chemical feedstocks into lighter product streams. However, these conventional zeolitic catalysts may not be able to convert polyaromatic compounds in a feedstock due to the pores in the zeolites being too small and not allowing the large polyaromatic compounds to diffuse into the active sites located inside the zeolite. Further, multiple processes may be utilized to incorporate mesopores into a zeolite. However, for some processes, in order to increase the acidity of the zeolite, an additional ion-exchange step is required to lower the alkaline cations (such as Na⁺ which neutralize acidic sites on the zeolite) associated with the zeolite so that the zeolite can be used as a catalyst. Thus, this requires additional time, materials, and costs associated with conducting this additional ion-exchange step. As such, a simpler method is needed.

According to embodiments described herein, a method of producing nano-sized, mesoporous zeolite particles is disclosed where NaOH, along with NH₄NO₃, NH₄OH, or both, are utilized along with a surfactant in a single mixture in the synthesis of the zeolite. The use of NaOH and surfactant allows for the removal of silica components to form mesopores, and maintain the zeolite structure. Additionally, the use of NH₄NO₃, NH₄OH, or both, allows for ion exchange of the zeolite (NH₄⁺ ion-exchanges Na⁺). These methods of producing nano-sized, mesoporous zeolite particles form these mesoporous zeolites in a “one-step” synthesis, where an ion-exchange occurs simultaneously during the formation of the mesopores. As such, avoiding the need to perform an entirely separate ion-exchange step allows for a simpler method of producing the nano-sized, mesoporous zeolite particles, decreasing the time, amount of materials, and costs associated with conventional methods, and increasing the performance of the zeolite as a catalyst due to the presence of mesopores, and the nano-size zeolite particles.

According to one or more embodiments of the present disclosure, a method of forming nano-sized, mesoporous zeolite particles may comprise contacting initial nano-sized zeolite particles with a first mixture to form nano-sized, mesoporous zeolite particles from the initial nano-sized zeolite particles, wherein the initial nano-sized zeolite particles have a particle size of less than or equal to 100 nm and have an average pore size of less than 2 nm. The first mixture may comprise NaOH; NH₄NO₃, NH₄OH, or both; and a surfactant. The NaOH and the surfactant may interact with the initial nano-sized zeolite particles to remove one or more silica components of the initial nano-sized zeolite particles to form mesopores, wherein the nano-sized, mesoporous zeolite particles may have an average pore size of at least 2 nm. The NH₄NO₃, NH₄OH, or both may interact with the initial nano-sized zeolite particles to exchange at least one positively-charged ion from the NH₄NO₃, NH₄OH, or both with at least one positively-charged ion from the initial nano-sized zeolite particles.

These and other embodiments are described in more detail in the Detailed Description. It is to be understood that both the foregoing general description and the following detailed description present embodiments of the invention, and are intended to provide an overview or framework for understanding the nature and character of the invention as it is claimed.

### DETAILED DESCRIPTION

References will now be made in greater detail to various embodiments. According to one or more embodiments, a method of forming nano-sized, mesoporous zeolite particles may comprise contacting initial nano-sized zeolite particles with a first mixture to form nano-sized, mesoporous zeolite particles from the initial nano-sized zeolite particles. In some embodiments, components of the first mixture may react with the initial nano-sized zeolite particles to remove one or more silica components from the initial nano-sized zeolite particles to form mesopores while other components of the first mixture may interact with the initial nano-sized zeolite particles to exchange at least one positively-charged ion from the framework of the initial nano-sized zeolite particles.

As used throughout this disclosure, the term “nano-sized” may refer to a zeolite particle where the particle size is less than or equal to 100 nm. The term “initial nano-sized zeolite particle” may refer to a zeolite particle where the particle size is less than or equal to 100 nm and the average pore size is microporous, thus having an average pore size of less than or equal to 2 nm. The term “nano-sized, mesoporous zeolite particle” may refer to a zeolite particle where the particle size is less than or equal to 100 nm and the average pore size is mesoporous, thus having an average pore size of at least 2 nm.

As used throughout this disclosure, the term “mesoporous” may describe a material containing pores with diameters from 2 mn and 50 nm. By way of comparison, conventional zeolites that are utilized in hydrocracking catalysts are the zeolites that are microporous, meaning that they have an average pore size of less than 2 nm and may not include mesopores. In some embodiments, the nano-sized, mesoporous zeolite particles may comprise mesopores with an average pore size of 2 nm, of 5 nm, of 10 nm, of 15 nm, of 20 nm, of 25 nm, of 30 nm, of 35 nm, of 40 nm, of 45 nm, of 50 nm, or a range where any two listed values comprise the endpoints of that range. The average pore size may be determined from a nitrogen physisorption analysis. Further, the average pore size may be confirmed by transmission electron microscope (TEM) characterization.

As used throughout this disclosure, “zeolites” may refer to micropore-containing inorganic materials with regular intra-crystalline cavities and channels of molecular dimension. The microporous structure of zeolites (for example, 0.3 nm to 1 nm pore size) may render large surface areas and desirable size-/shape-selectivity, which may be advantageous for catalysis. The zeolites described may include, for example, aluminosilicates, titanosilicates, or pure silicates. The zeolites described may include the general formula MₓAlₓSi₁₋ₓO₂·yH₂O where M is either a metal ion or H⁺, the value of x is between 0 and 1, and y is the number of water molecules in the formula unit. While there may be a wide range of possible structures for these zeolites, a commonality may be that they are formed by the linking of the corner oxygen atoms of AlO₄ and SiO₄ tetrahedra to form covalent network structures. In one or more embodiments, the zeolites described may include micropores (present in the microstructure of a zeolite), and additionally include mesopores. As used throughout this disclosure, micropores refer to pores in a zeolite structure that have a diameter of less than or equal to 2 nm and greater than or equal to 0.1 nm. In some embodiments, the zeolites presently described may be characterized as Beta (that is, having an aluminosilicate BEA framework type).

In one or more embodiments, contacting the initial nano-sized zeolite particles with the first mixture may comprise adding the initial nano-sized zeolite particles to the first mixture. In some embodiments, the initial nano-sized zeolite particles may start in a solution, where the initial nano-sized zeolite particles may be separated, washed, dried, and/or calcined before being added to the first mixture. In other embodiments, the initial nano-sized zeolite particles may be obtained already in a dried powdered form, where the initial nano-sized zeolite particles as a dried powder are contacted with the first mixture. The initial nano-sized zeolite particles may be added to the first mixture, mixed with the first mixture, stirred with the first mixture, poured into the first mixture, combinations thereof, or the like. The first mixture may be added to the initial nano-sized zeolite particles, may be mixed with the initial nano-sized zeolite particles, may be stirred with the initial nano-sized zeolite particles, may be poured into a vessel containing the initial nano-sized zeolite particles, combinations thereof, or the like.

In one or more embodiments, the initial nano-sized zeolite particles and/or the nano-sized, mesoporous zeolite particles may have a particle size of less than or equal to 100 nm. In some embodiments, the initial nano-sized zeolite particles and/or the nano-sized, mesoporous zeolite particles may comprise a particle size of from 10 nm to 20 nm, from 20 nm to 30 nm, from 30 nm to 40 nm, from 40 nm to 50 nm, from 50 nm to 60 nm, from 60 nm to 70 nm, from 70 nm to 80 nm, from 80 nm to 90 nm, from 90 nm to 100 nm, or any combination of these ranges.

In one or more embodiments, forming the initial nano-sized zeolite particles may comprise processes such as, but not limited to, fabricating the initial nano-sized zeolite particles in a colloidal solution or directly acquiring such a colloidal solution comprising the initial nano-sized zeolite particles. It should be understood that numerous methods may be available for fabricating a colloidal solution containing initial nano-sized zeolite particles, and that methods not explicitly described for fabricating a colloidal solution containing initial nano-sized zeolite particles are contemplated in this disclosure. As used in this disclosure, a “colloidal solution” refers to a mixture of at least two materials where the solution has a state of subdivision such that the molecules or polymolecular particles dispersed in a medium have at least one dimension between approximately 1 nm and 1 micron (μm).

According to one or more embodiments, forming the initial nano-sized zeolite particles may comprise mixing at least a quaternary ammonium salt, silica source material, alumina source material, and water to form a solution, and autoclaving the solution containing at least the quaternary ammonium salt, silica source material, alumina source material, and water to form initial nano-sized zeolite particles in a colloidal solution. In one embodiment, the quaternary ammonium salt may be tetraethylammonium hydroxide (TEAOH). In some embodiments, the solution containing at least a quaternary ammonium salt, silica source material, alumina source material, and water may have a molar ratio of these contents of 1 mole of alumina source material, from 15 moles to 40 moles of quaternary ammonium salt (such as from 15 moles to 30 moles, or from 30 moles to 40 moles), from 20 moles to 500 moles of silica source material (such as from 20 moles to 250 moles, or from 250 moles to 500 moles), and from 500 moles to 1000 moles of water (such as from 500 moles to 750 moles, or from 750 moles to 100 moles).

In some embodiments, the solution containing at least the quaternary ammonium salt, silica source material, alumina source material, and water, as described previously in this disclosure, may be autoclaved for 1 to 7 days at, for example, 40 rotations per minute (rpm) to 80 rpm (such as 60 rpm) at 100° C. to 150° C. (such as from 130° C. to 150° C., or 140° C.) to form the initial nano-sized zeolite particles. Prior to autoclaving, the solution containing at least a quaternary ammonium salt, silica source material, alumina source material, and water may be aged, such as by stirring for 4 hours at room temperature. It should be understood that the described autoclaving and aging steps may be modified to some degree depending upon the exact components of the solution that is autoclaved and the desired zeolite particle structure to be formed.

In one or more embodiments, the first mixture that contacts the initial nano-sized zeolite particles may comprise NaOH, NH₄NO₃ and/or NH₄OH, and a surfactant. The NaOH may act as a desilication agent where the term “desilication agent” may refer to a chemical that is able to remove silica from the framework of the initial nano-sized zeolite particles. The NH₄NO₃ and/or NH₄OH may act as an ion-exchange agent where the term “ion-exchange agent” may refer to a chemical that is able to transfer an ion of the ion-exchange agent with at least one ion from the framework of the initial nano-sized zeolite particles. The term “surfactant” may refer to a chemical that tends to reduce the surface tension between two liquids, between a gas and a liquid, or between a liquid and a solid. In some embodiments, the surfactant may comprise a chemical compound containing a positively-charged portion with a long carbon chain that is neither positively-charged nor negatively-charged. In some embodiments, the surfactant may comprise a quaternary ammonium compound that may adsorb to a surface of a forming nano-sized zeolite particle. For example, in one or more embodiments, the surfactant may comprise cetyltrimethyl ammonium bromide (CTAB).

In some embodiments, the first mixture may comprise NaOH as the only desilication agent. In other embodiments, the first mixture may comprise NaOH and at least one or more other desilication agents. In some embodiments, the first mixture may comprise NH₄NO₃ as the only ion-exchange agent. In other embodiments, the first mixture may comprise NH₄OH as the ion-exchange agent and desilication agent. In other embodiments, the first mixture may comprise both NN₄NO₃ and NH₄OH as ion-exchange agents. In other embodiments, the first mixture may comprise NH₄NO₃, NH₄OH, and at least one more ion-exchange agent. In some embodiments, the first mixture may comprise only one surfactant. In other embodiments, the first mixture may comprise at least one or more surfactants.

in one or more embodiments, after contacting the initial nano-sized zeolite particles with the first mixture, this mixture may be heated to a temperature of at least 25° C. to 200° C. for 30 minutes to 24 hours. In some embodiments, the temperature may be at least 25° C., at least 50° C., at least 75° C., at least 100° C., at least 125° C., at least 150° C., at least 175° C., or even at least 200° C. In some embodiments, the initial nano-sized zeolite particles and the first mixture may be contacted at this temperature for at least 30 minutes, at least 1 hour, at least 2 hours, at least 5 hours, at least 10 hours, at least 15 hours, at least 20 hours, or even at least 24 hours.

The NaOH and/or the surfactant may interact with the initial nano-sized zeolite particles to remove one or more silica components from the initial nano-sized zeolite particles. Without being bound by a theory, it is believed that the NaOH may remove one or more weakly bonded SiOₓ compounds from the initial nano-sized zeolite particle framework, where x may be any integer greater than 1. A surfactant molecule may interact with another surfactant molecule and position the positively-charged portion of the surfactant molecules outward and the long carbon chain of the surfactant molecules inward so that the surfactant molecules form a micelle. The outer positively-charged portions of the surfactant micelles may interact with the negatively-charged silicate and/or aluminate compounds of the pores of the initial nano-sized zeolite particle framework. The surfactant can completely or partially protect the zeolite structure from being destroyed or collapsing during desilication. In some embodiments, the presence of the surfactant micelles near the pores of the initial nano-sized zeolite particle framework may direct the NaOH towards the pores of the initial nano-sized zeolite particle framework. When the one or more SiOx compounds are removed from the initial nano-sized zeolite particle framework, the pores of the initial nano-sized zeolite particle may increase in size, where at least one or more pores are now mesoporous (i.e., having a pore size ranging from 2 nm to 50 nm). In some embodiments, at least one or more pores of the initial nano-sized zeolite particle may increase from the microporous range (i.e., having a pore size of less than 2 nm) to the mesoporous range.

In one or more embodiments, the NH₄NO₃ and/or NH₄OH may interact with the initial nano-sized zeolite particles to exchange at least one positively-charged ion from the NH₄NO₃ and/or NH₄OH with at least one positively-charged ion from the initial nano-sized zeolite particles. In some embodiments, utilizing NaOH as the desilication agent permits an ion-exchange with the initial nano-sized zeolite particles, where positively-charged sodium (Na⁺) ions may be incorporated into the initial nano-sized zeolite particle framework. The NH₄NO₃ and/or NH₄OH may permit at least one positively-charged ion to replace the positively-charged sodium ions incorporated into the initial nano-sized zeolite framework, where the positively-charged ion that replaces the positively-charged sodium ions incorporated into the initial nano-sized zeolite framework may be NH₄⁺.

In one or more embodiments, the ion-exchange between the NH₄NO₃ and/or NH₄OH and the initial nano-sized zeolite particles may occur simultaneously with the desilication process where one or more silica components are removed from the initial nano-sized zeolite particles. It is noted that conventional methods of forming mesoporous zeolite particles require a separate post ion-exchange procedure, where an additional calcination step is needed. These conventional processes thus require additional time, resources, and costs into conducting this additional ion-exchange process. The process used in the present disclosure thus avoids having to perform this additional ion-exchange process and decreases the time, amount of materials, and costs associated with the process of forming mesoporous zeolite particles.

In one or more embodiments, after contacting the initial nano-sized zeolite particles with the first mixture, nano-sized, mesoporous zeolite particles may be formed from the initial nano-sized zeolite particles and be present in a second mixture. The second mixture refers to the reacted first mixture where one or more initial nano-sized zeolite particles have been transformed into one or more nano-sized, mesoporous zeolite particles after heating the first mixture. In some embodiments, the method of forming nano-sized, mesoporous zeolite particles may further comprise separating the nano-sized, mesoporous zeolite particles from the other contents of the second mixture. The separation of the nano-sized, mesoporous zeolite particles from the other contents of the second mixture may be performed by a solids/liquids separation technique (for example, centrifugation, filtering, etc.). In some embodiments, the separated nano-sized, mesoporous zeolite particles may be washed with one or more liquids (for example, water, an alcohol, etc.). The separated and washed nano-sized, mesoporous zeolite particles may be dried at a temperature of at least 100° C. for at least 30 minutes. The separated and washed nano-sized, mesoporous zeolite particles may be dried at a temperature of at least 100° C., at least 125° C., at least 150° C., at least 175° C., at least 200° C., at least 225° C., at least 250° C., at least 275° C., or even at least 300° C. In some embodiments, the separated and washed nano-sized, mesoporous zeolite particles may be dried for at least 30 minutes, at least 4 hours, at least 5 hours, at least 10 hours, at least 20 hours, or even at least 24 hours. The separated, washed, and then dried nano-sized, mesoporous zeolite particles may then be calcined at a temperature of 250° C. to 600° C. for a time period of 30 minutes to an hour, where the temperature is increased at a temperature of 1-4° C./min. The separated, washed, and then dried nano-sized, mesoporous zeolite particles may be calcined at a temperature of at least 250° C., at least 300° C., at least 350° C., at least 400° C., at least 450° C., at least 500° C., at least 550° C., or even at least 600° C. In some embodiments, the separated, washed, and then dried nano-sized, nesoporous zeolite particles may be calcined for at least 30 minutes, at least 45 minutes, or even at least 4 hours.

In one or more embodiments, the nano-sized, mesoporous zeolite particles may have a pore volume of from 0.5 mL/g to 1.2 mL/g. The term “pore volume” may refer to the total volume of the pores of the nano-sized, mesoporous zeolite particles per gram of the nano-sized, mesoporous zeolite particles. In some embodiments, the nano-sized, mesoporous zeolite particles may have a pore volume of at least 0.5 mL/g, at least 0.55 mL/g, at least 0.6 mL/g, at least 0.65 mL/g, at least 0.7 mL/g, at least 0.75 mL/g, at least 0.8 mL/g, at least 0.85 mL/g, at least 0.9 mL/g, at least 0.95 mL/g, at least 1.0 mL/g, at least 1.2 mL/g, or a range where any two listed numbers comprise the endpoints of that range.

In one or more embodiments, the nano-sized, mesoporous zeolite particles may have a surface area of from 500 m²/g to 700 m²/g. The term “surface area” may refer to the total area of the surface of the nano-sized, mesoporous zeolite particles per gram of nano-sized, mesoporous zeolite particles. In some embodiments, the nano-sized, mesoporous zeolite particles may have a surface area of at least 500 m²/g, at least 525 m²/g, at least 550 m²/g, at least 575 m²/g, at least 600 m²/g, at least 625 m²/g, at least 650 m²/g, at least 675 m²/g, at least 700 m²/g, or a range where any two listed numbers comprise the endpoints of that range.

In one or more embodiments, the nano-sized, mesoporous zeolite particles presently disclosed may be incorporated into a catalyst. The catalyst may be utilized as a hydrocracking catalyst in the pretreatment of heavy oils, as described subsequently in detail. As such, the catalysts which comprises the nano-sized, mesoporous zeolite particles may be referred to herein as a “hydrocracking catalyst.” However, it should be understood that, while the hydrocracking catalysts are described in the context of pretreatment (for example, hydrotreatment) of a heavy oil, the hydrocracking catalysts described herein may be useful for other catalytic reactions for the production of other petroleum and petrochemical product, such as catalytic cracking.

In one or more embodiments, the hydrocracking catalyst may comprise the presently described nano-sized, mesoporous zeolite particles, one or more metal oxide support materials, and one or more metal catalysts. The hydrocracking catalysts presently described may have a material composition comprising from 10 wt. % to 80 wt. % of one or more metal oxide support materials (for example, alumina), from 18 wt. % to 32 wt. % of metal catalyst material, and from 10 wt. % to 60 wt. % of the nano-sized, mesoporous zeolite particles.

The metal catalyst material may comprise one or more metals from IUPAC Groups 5, 6, 8, 9, or 10 of the periodic table. The hydrocracking catalyst may comprise one or more metals from IUPAC Groups 5 or 6, and one or more metals from IUPAC Groups 8, 9, or 10 of the periodic table. For example, the hydrocracking catalyst may comprise molybdenum or tungsten from IUPAC Group 6 and nickel or cobalt from IUPAC Groups 8, 9, or 10. In one embodiment, the hydrocracking catalyst may comprise tungsten and nickel metal catalyst. In another embodiment, the hydrocracking catalyst may comprise molybdenum and nickel metal catalyst. For example, in one embodiment, the hydrocracking catalyst may comprise from 20 wt. % to 26 wt. % of a sulfide or oxide of tungsten, from 4 wt. % to 6 wt. % of an oxide or sulfide of nickel, from 10 wt. % to 70 wt. % of a metal oxide support material such as alumina, and from 10 wt. % to 60 wt. % of the nano-sized, mesoporous zeolite particles. In another embodiment, the hydrocracking catalyst may comprise from 14 wt. % to 16 wt. % of an oxide or sulfide of molybdenum, from 4 wt. % to 6 wt. % of an oxide or sulfide of nickel, from 20 wt. % to 80 wt. % of a metal oxide support material such as alumina, and from 10 wt. % to 60 wt. % of the nano-sized, mesoporous zeolite particles.

The hydrocracking catalysts described may be fabricated by providing the nano-sized, mesoporous zeolite particles and impregnating the nano-sized, mesoporous zeolite particles with one or more catalytic metals or by comulling the nano-sized, mesoporous zeolite particles with other components. In one embodiment, the nano-sized, mesoporous zeolite particles, active alumina (for example, boehmite alumina), and binder (for example, acid peptized alumina) may be mixed. An appropriate amount of water may be added to form a dough that can be extruded using an extruder. The extrudate may be dried at 80° C. to 120° C. for 4 hours to 10 hours, and then calcinated at 500° C. to 600° C. for 4 hours to 6 hours. To this alumina support material, which includes the nano-sized, mesoporous zeolite particles, may then be added the metal catalyst material such as oxide or sulfides of Mo, Ni, W, or Ni. For example, in one embodiment, the support material may be impregnated with one or more metals to form the hydrocracking catalyst. According to described embodiments, the impregnation of the support material may comprise contacting the support material with a solution comprising one or more metal catalyst precursors. For example, the support material may be submerged in the solution comprising the one or more metal catalyst precursors, an impregnation method sometimes referred to as a saturated impregnation. In embodiments of saturated impregnation, the support may be submerged in an amount of solution comprising the metal catalyst precursors 2 to 4 times of that which is absorbed by the support, and the remaining solution may subsequently be removed.

According to another embodiment, the impregnation may be by incipient wetness impregnation, sometimes referred to as capillary impregnation or dry impregnation. In embodiments of incipient wetness impregnation, the metal catalyst precursor containing solution is contacted with the support, where the amount of solution is approximately equal to the pore volume of the support and capillary action may draw the solution into the pores. After the contacting of the support material with the solution, the support material may be calcined at a temperature of at least 500° C. (such as from 500° C. to 600° C.) for a time of at least 3 hours (such as 3 hours to 6 hours). For example, the calcining may be at a temperature of 500° C. for 4 hours. Generally, the impregnation process will allow for attachment of the metal catalyst onto the support materials (that is, the zeolite and metal oxide support). The metal catalyst precursors may include one or more of Ni, W, Mo, Co, and following the impregnation, are present on the catalyst support as compounds comprising Ni, W, Mo, Co, or combinations thereof. Two or more metal catalyst precursors may be utilized when two metal catalysts are desired. However, some embodiments may include only one of Ni, W, Mo, or Co. For example, the catalyst support material may be impregnated by a mixture of nickel nitrate hexahydrate (that is, Ni(NO₃)₂·6H₂O) and ammonium metatungstate (that is, (NH₄)₆H₂W₁₂O₄₀) if a W—Ni catalyst is desired. While it should be understood that the scope of the present disclosure should not be limited by the metal catalyst precursor selected, other suitable metal catalyst precursors may include cobalt nitrate hexahydrate (Co(NO₃)₂·6H₂O), ammonia heptamolybdate ((NH₄)₆Mo₇O₂₄·4H₂O), or ammonium molybdate ((NH₄)₂MoO₄). Following impregnation, the impregnated metal catalysts may be present as a metal oxide, such as WO₃, MoO₃, NiO, and CoO, and are referred to in this disclosure as “metal catalyst materials.” While these metal catalyst materials may include metal oxides, it should be appreciated that the metal catalyst materials are distinct from the metal oxide support material of the catalyst which may, in some embodiments, be alumina.

As described herein, the nano-sized, mesoporous zeolite particles may be utilized as a hydrocracking catalyst in the upgrading processing of heavy oils, such as crude oil. Without being bound by theory, the nano-sized, mesoporous zeolite particles may be particularly useful in cracking crude oils that contain asphaltenes, as the mesopores allow for the asphaltenes to penetrate the interior of the zeolite to reach additional active sites. Such upgrading processes may be a pretreatment step prior to other petrochemical processing such as relining operations utilizing, for example, one or more of steam cracking, hydrocracking, thermal cracking, or fluid catalytic cracking. Generally, the upgrading process may remove one or more of at least a portion of nitrogen, sulfur, and one or more metals from the heavy oil, and may additionally break aromatic moieties in the heavy oil. According to one or more embodiments, the heavy oil may be treated with a hydrodemetalization catalyst, a transition catalyst, a hydrodenitrogenation catalyst, and a hydrocracking catalyst. The hydrodemetalization catalyst, transition catalyst, hydrodenitrogenation catalyst, and hydrocracking catalyst may be positioned in series, either contained in a single reactor, such as a packed bed reactor with multiple beds, or contained in two or more reactors arranged in series.

### EXAMPLES

Examples are provided herein which may disclose one or more embodiments of the present disclosure. However, the Examples should not be viewed as limiting on the claimed embodiments hereinafter provided.

### Example 1—Synthesis of Initial Nano-Sized Zeolite Beta

0.27 grams of aluminum metal was dissolved in 20 grams of an aqueous solution containing 35 wt. % tetraethylammonium hydroxide (TEAOH). The solution was heated to 50° C. under vigorous stirring until all the metal was completely dissolved, forming a clear aluminum solution. In another beaker, 12 grams of fumed silica was added to 11.25 gams of the aqueous solution containing 35 wt. % TEAOH. This solution was stirred until a uniform alumiriosilicate fluid gel was formed. The aluminum solution was added to the aluminosilicate fluid gel. This mixture was stirred for 4 hours to form a slurry. The slurry was then transferred to a 125 mL polytetrafluoro ethylene (PTFE) lined stainless steel autoclave. The autoclave was mounted on a rotation rack installed inside an oven. The autoclave was then rotated at 60 RPM while being heated to 170° C. for 3 days. The autoclave was then quenched to room temperature and the solid product was separated from the liquid using an ultracentrifuge at 10,000 RPM. The resulting solid product was washed with purified water twice and was separated from the liquid in the ultracentrifuge between each washing and after the washing was completed.

### Example 2—Synthesis of Nano-Sized, Mesoporous Zeolite Beta where Ion-Exchange Agent is NH₄NO₃

0.4 g of NaOH, 5.0 g of NH₄NO₃, and 62.5 g of H₂O were added to a beaker and stirred for 2 minutes. 4.56 g of nano-sized zeolite Beta and 1.13 g of cetyltrimethyl ammoniwn bromide (CTAB) were added into the solution of NaOH and NH₄NO₃ and the mixture was stirred for 30 minutes. The mixture was transferred into a PTFE-lined autoclave and heated in an oven at 100° C. for 10 hours. The formed colloid was washed several times with distilled water, centrifuged at 12,000 rpm, and dried in an oven at 110° C. overnight. The dried solid was calcined at 550° C. for 4 hours at a heating rate of 2° C./min to remove the organic agents.

### Example 3—Synthesis of Nano-Sized, Mesoporous Zeolite Beta where Ion-Exchange Agent is NH₄OH

0.1 g of NaOH and 62.5 g of 0.5 M NH₄OH solution were added to a beaker and stirred for 2 minutes. 4.56 g of nano-sized zeolite Beta and 1.13 g of cetyltrimethyl ammonium bromide (CTAB) were added into the solution of NaOH and NH₄OH solution and the mixture was stirred for 30 minutes. The mixture was transferred into a PTFE-lined autoclave and heated in an oven at 100° C. for 10 hours. The formed colloid was washed several times with distilled water, centrifuged at 12,000 rpm, and dried in an oven at 110° C. overnight. The dried solid was calcined at 550° C. for 4 hours with a heating rate of 2° C./min to remove the organic agents.

### Comparative Example 1—Synthesis of Nano-Sized, Mesoporous Zeolite Beta without an Ion-Exchange Agent

0.8 g of NaOH and 62.5 g of H₂O were added to a beaker and stirred for 2 minutes. 4.56 g of nano-sized zeolite Beta and 1.13 g of cetyltrimethyl ammonium bromide (CTAB) were added into the solution of NaOH, and the mixture was stirred for 30 minutes. The mixture was transferred into a PTFE-lined autoclave and heated in an oven at 100° C. for 10 hours. The formed colloid was washed several times with distilled water, centrifuged at 12,000 rpm, and dried in an oven at 110° C. overnight. The dried solid was calcined at 550° C. for 4 hours with a heating rate of 2° C./min to remove the organic agents.

### Example 4—Characterization of Examples

Each obtained nano-sized, mesoporous zeolite Beta was characterized and the results are summarized in Table 1:

TABLE 1
Textual Characteristics of Each Nano-Sized, Mesoporous Zeolite Beta

| | Initial Nano- | | | |
|---|---|---|---|---|
| | Sized Zeolite | Comparative | | |
| | Beta | Example 1 | Example 2 | Example 3 |
| Surface Area, m²/g | 590 | 583 | 601 | 626 |
| Pore Volume, mL/g | 0.83 | 0.97 | 1.05 | 1.06 |
| Average Pore Size, | 1.0 | 6.63 | 6.96 | 6.79 |
| nm | | | | |
| Crystallinity % | 100 | 104 | 99 | 97 |
| Na⁺ wt. % | — | 0.213 | 0.02 | 0.04 |
| SiO₂/Al₂O₃ Molar | 19.2 | 20.49 | 21.01 | 21.65 |
| Ratio | | | | |

From the characterization results shown in Table 1, it can be seen that, compared with desilication with only NaOH and CTAB solution, a lower Na content (<0.04 wt. %) can be obtained with the NaOH, NH₄NO₃, and CTAB or NAOH, NH₄OH, CTAB system. In hydrocracking catalyst synthesis, the Na content in the zeolite used should be <0.05 wt. %. Therefore, this Na content can meet the requirement of a hydrocracking catalyst for minimum Na content. For the comparable sample, the Na content is 0.213 wt. %, much higher than 0.05 wt. %. Meanwhile, the samples made by the invented methods have a high surface area, pore volume, and satisfactory crystallinity.

The present disclosure includes one or more non-limiting aspects. A first aspect includes a method of forming nano-sized, mesoporous zeolite particles, the method comprising contacting initial nano-sized zeolite particles with a first mixture to form nano-sized, mesoporous zeolite particles from the initial nano-sized zeolite particles, wherein the initial nano-sized zeolite particles have a particle size of less than or equal to 100 nm and have an average pore size of less than 2 nm, the first mixture comprises: NaOH; NH₄NO₃, NH₄OH, or both; and a surfactant, the NaOH and the surfactant interact with the initial nano-sized zeolite particles to remove one or more silica components of the initial nano-sized zeolite particles to form mesopores, wherein the nano-sized, mesoporous zeolite particles have an average pore size of at least 2 nm, and the NH₄NO₃, NH₄OH, or both interact with the initial nano-sized zeolite particles to exchange at least one positively-charged ion from the NH₄NO₃, NH₄OH, or both with at least one positively-charged ion from the initial nano-sized zeolite particles.

A second aspect includes any above aspect, wherein the nano-sized, mesoporous zeolite particles are present in a second mixture, and further comprising separating the nano-sized, mesoporous zeolite particles from the second mixture and washing, drying, and calcining the nano-sized, mesoporous zeolite particles.

A third aspect includes any above aspect, wherein the surfactant comprises cetyltrimethyl ammonium bromide (CTAB).

A fourth aspect includes any above aspect, wherein one or more of the at least one positively-charged ion from the NH₄NO₃, NH₄OH, or both are NH₄⁺.

A fifth aspect includes any above aspect, wherein one or more of positively-charged ion from the initial nano-sized zeolite particles are Na⁺.

A sixth aspect includes any above aspect, wherein contacting the initial nano-sized zeolite particles with a first mixture is at a temperature of at least 100° C.

A seventh aspect includes any above aspect, wherein the initial nano-sized zeolite particles comprise zeolite Beta.

An eighth aspect includes any above aspect, wherein the nano-sized, mesoporous zeolite particles have an average pore size of at least 2 nm.

A ninth aspect includes any above aspect, wherein the nano-sized, mesoporous zeolite particles have a pore volume of from 0.5 to 1.0 mL/g.

A tenth aspect includes any above aspect, wherein the nano-sized, mesoporous zeolite particles have a surface area of from 500 m²/g to 700 m²/g.

An eleventh aspect includes any above aspect, further comprising utilizing the nano-sized, mesoporous zeolite particles in a catalyst, wherein the catalyst further comprises a metal oxide support material and one or more metal catalyst materials.

A twelfth aspect includes any above aspect, wherein the metal oxide support material comprises alumina.

A thirteenth aspect includes any above aspect, wherein the one or more metal catalyst materials comprise an oxide or sulfide of W, Mo, Ni, or Co.

A fourteenth aspect includes any above aspect, further comprising utilizing the catalyst to upgrade heavy oil containing aromatics.

A fifteenth aspect includes any above aspect, further comprising forming the initial nano-sized zeolite particles, the forming comprising: mixing at least a quaternary ammonium salt, silica source material, alumina source material, and water to form a solution and autoclaving the solution to form the initial nano-sized zeolite particles of the first mixture.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

For the purposes of describing and defining the present inventive technology, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a. function of a single parameter or a plurality of parameters.

It is also noted that recitations herein of “at least one” component, element, etc., should not be used to create an inference that the alternative use of the articles “a” or “an” should be limited to a single component, element, etc.

It should be understood that any two quantitative values assigned to a property may constitute a range of that property, and all combinations of ranges formed from all stated quantitative values of a given property are contemplated herein.

What is claimed is:

1. A method of forming nano-sized, mesoporous zeolite particles, the iriethod comprising:
contacting initial nano-sized zeolite particles with a first mixture to form nano-sized, mesoporous zeolite particles from the initial nano-sized zeolite particles, wherein:
the initial nano-sized zeolite particles have a particle size of less than or equal to 100 nm and have an average pore size of less than 2 nm;
the first mixture comprises:
NaOH;
NH₄NO₃, NH₄OH, or both; and
a surfactant;
the NaOH and the surfactant interact with the initial nano-sized zeolite particles to remove one or more silica components of the initial nano-sized zeolite particles to form mesopores, wherein the nano-sized, mesoporous zeolite particles have an verage pore size of at least 2 nm; and
the NH₄NO₃, NH₄OH, or both interact with the initial nano-sized zeolite particles to exchange at least one positively-charged ion from the NH₄NO₃, NH₄OH, or both with at least one positively-charged ion from the initial nano-sized zeolite particles.

2. The method of claim 1, wherein the nano-sized, mesoporous zeolite particles are present in a second mixture, and further comprising:
separating the nano-sized, mesoporous zeolite particles from the second mixture; and
washing, drying, and calcining the nano-sized, mesoporous zeolite particles.

3. The method of claim 1, wherein the surfactant comprises cetyltrimethyl ammonium bromide (CTAB).

4. The method of claim 1, wherein one or more of the at least one positively-charged ion from the NH₄NO₃, NH₄OH, or both are NH₄⁺.

5. The method of claim 1, wherein one or more of the at least one positively-charged ion from the initial nano-sized zeolite particles are Na⁺.

6. The method of claim 1, wherein contacting the initial nano-sized zeolite particles with a first mixture is at a temperature of at least 100° C.

7. The method of claim 1, wherein the initial nano-sized zeolite particles comprise zeolite Beta.

8. The method of claim 1, wherein the nano-sized, mesoporous zeolite particles have an average pore size of at least 2 nm.

9. The method of claim 1, wherein the nano-sized, mesoporous zeolite particles have a pore volume of from 0.5 to 1.0 mL/g.

10. The method of claim 1, wherein the nano-sized, mesoporous zeolite particles have a surface area of from 500 m²/g to 700 m²/g.

11. The method of claim 1, further comprising utilizing the nano-sized, mesoporous zeolite particles in a catalyst, wherein the catalyst further comprises a metal oxide support material and one or more metal catalyst materials.

12. The method of claim 11, wherein the metal oxide support material comprises alumina.

13. The method of claim 11, wherein the one or more metal catalyst materials comprise an oxide or sulfide of W, Mo, Ni, or Co.

14. The method of claim 11, further comprising utilizing the catalyst to upgrade heavy oil containing aromatics.

15. The method of claim 1, further comprising forming the initial nano-sized zeolite particles, the forming comprising:
mixing at least a quaternary ammonium salt, silica source material, alumina source material, and water to form a solution; and
autoclaving the solution to form the initial nano-sized zeolite particles of the first mixture.
